(19) United States
(12) Patent Application Publication
(10) Pub. No.: US 2013/0111334 A1
(43) Pub. Date: May 2, 2013

(54) ELECTRONIC DEVICE AND PAGE PROCESSING METHOD THEREOF

(71) Applicants: HAI-SEN LIANG, Shenzhen City (CN); CHIH-SAN CHIANG, Tu-Cheng (TW); LING-JUAN JIANG, Shenzhen City (CN); XIANG HE, Shenzhen City (CN); HUA-DONG CHENG, Shenzhen City (CN); HAN-CHE WANG, Tu-Cheng (TW)

(72) Inventors: HAI-SEN LIANG, Shenzhen City (CN); CHIH-SAN CHIANG, Tu-Cheng (TW); LING-JUAN JIANG, Shenzhen City (CN); XIANG HE, Shenzhen City (CN); HUA-DONG CHENG, Shenzhen City (CN); HAN-CHE WANG, Tu-Cheng (TW)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/465,040

(22) Filed: May 7, 2012

(30) Foreign Application Priority Data
Oct. 28, 2011 (CN) 201110333538.0

(51) Int. Cl. G06F 17/00; G06F 3/041

(52) U.S. Cl. 715/252

(57) ABSTRACT

A page processing method for an electronic device with a touch screen is provided. The method includes the following steps: displaying a page of content on the touch screen, the displayed page consisting of a number of regions comprising a center region and a plurality of peripheral regions surrounding the center region; detecting a touch operation on the displayed page and generating a signal associated therewith; determining the touched region where the touch operation occurs; determining whether the touch operation is a mode switching operation according to the signal; and controlling the electronic device to switch between a browsing mode and a zooming mode according to the signal and the location of the touched region on the displayed page, if the touch operation is a mode switching operation. An electronic device using the page processing method is also provided.

### BACKGROUND

1. Technical Field

The present disclosure relates to an electronic device and a page processing method thereof.

2. Description of Related Art

Many electronic devices, e.g., mobile phones, digital photo frames, and electronic readers (e-reader), are capable of storing and displaying electronic documents (e.g., digital images, digital texts, etc). The readability of these electronic devices deviates greatly from that of real paper print. For example, when people flip a page of an electronic document on these electronic devices, the new page materializes without the satisfying visual effect of turning a page; as a result, it is difficult for people to get the feeling of reading real paper. Furthermore, buttons on the menu bar displayed on the screen of the electronic device is selected to switch different display modes such as full screen mode, and half screen mode etc., and to control the size of the displayed page such as 100%, 150% and 50% etc, which is not enough to satisfy all tastes and personalities.

Therefore, what is needed is an electronic device and a page processing method thereof to alleviate the limitations described above.

### BRIEF DESCRIPTION OF THE DRAWINGS

The components in the drawings are not necessarily drawn to scale, the emphasis instead being placed upon clearly illustrating the principles of an electronic device and a page processing method thereof. Moreover, in the drawings, like reference numerals designate corresponding sections throughout the several views.

FIG. 1 is a block diagram of an electronic device in accordance with an exemplary embodiment.

FIG. 2 is a schematic diagram of the electronic device of FIG. 1.

FIGS. 3-7 are schematic diagrams of the electronic device of FIG.2, showing the page processing process, in accordance with an exemplary embodiment.

FIG. 8 is a flowchart of a page processing method for electronic devices, such as the one of FIG. 1, in accordance with the exemplary embodiment.

### DETAILED DESCRIPTION

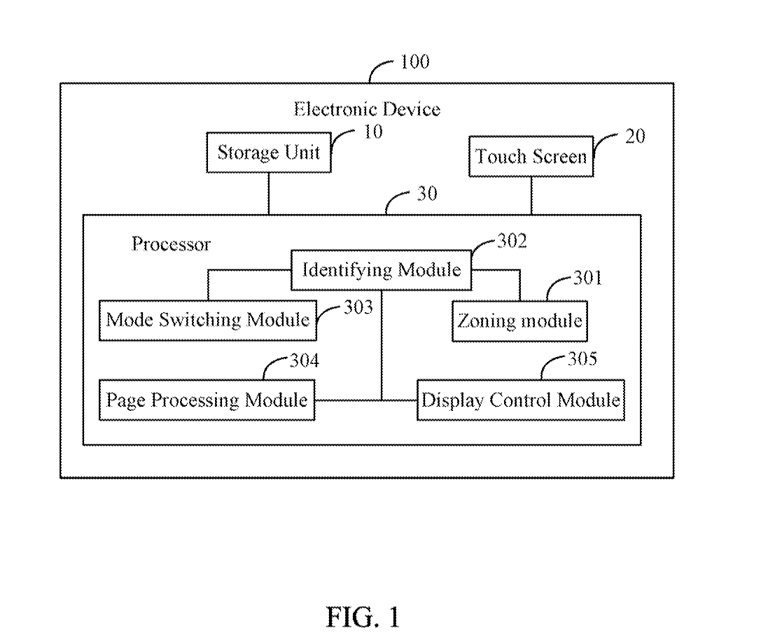

Referring to FIG. 1, an electronic device 100 is disclosed as an exemplary embodiment. The electronic device 100 includes a storage unit 10, a touch screen 20, and a processor 30. The storage unit 10 stores a plurality of electronic files. The electronic device 100 is an electronic reader. In alternative embodiments, the electronic device 100 can be other electronic devices with touch screens, such as a mobile phone, a tablet, a digital phone frame or the like.

In this embodiment, a user selects a display mode of the electronic device 100 via various operations on different regions of the displayed page on the touch screen 20. The electronic device 100 includes at least two display modes, that is, the zooming mode in which the displayed page is zoomable and the browsing mode in which the displayed page is unzoomable. For example, the user may doubleclick the center region of the displayed page or apply a zoom operation on the center region of the displayed page to command the electronic device 100 to enter the zooming mode. When the electronic device 100 is in the zooming mode, the user can manipulate the touch screen 20 for zooming and panning the displayed page. If the size of the displayed page is operated by the user to be 100%, the processor 30 controls the electronic device 100 to automatically enter the browsing mode. When the electronic device 100 is in the browsing mode, the user can manipulate the center region of the displayed page on touch screen 20 for panning the displayed page, and manipulate the peripheral regions of the displayed page for flipping the displayed page to simulate the flipping effect of turning a real page in a real book.

The touch screen 20 is configured for displaying a page of content and detecting a touch operation on the displayed page and generating a signal associated therewith. The signal includes the coordinate of the touched point of the touch screen 20.

The processor 30 includes a zoning module 301, an identification module 302, a mode switching module 303, a page processing module 304 and a display control module 305.

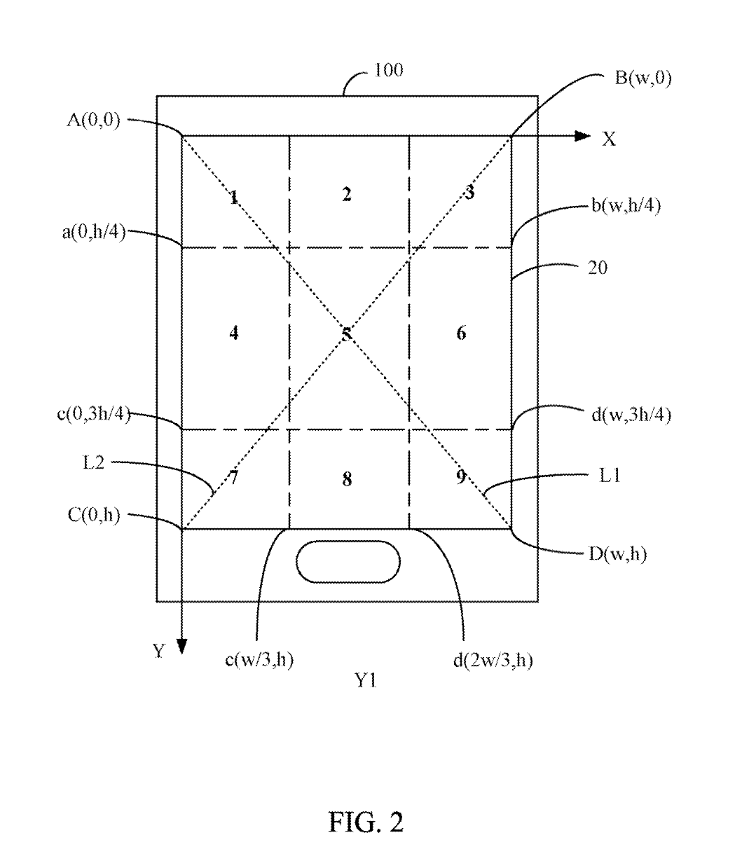

The zoning module 301 is configured to divide a displayed page on the touch screen 20 into a number of regions. The number of regions includes a center region and a number of peripheral regions surrounding the center region. Referring to FIG. 2, in the embodiment, the zoning module 301 divides the displayed page on the touch screen 20 into nine geometrically regular regions. The nine regions include a center region 5 and a number of peripheral regions 1-4, and 6-9 surrounding the center region 5. Whatever the size of the touch screen 20 is, the zoning module 301 divides the displayed page on the touch screen 20 into nine regions. In the embodiment, the touch screen 20 only displays one page at one time. In another embodiment, the touch screen 20 displays more than one page at one time. The zoning module 301 divides each of the displayed pages into a center region and a number of peripheral regions surrounding the center region.

The identifying module 302 is configured for determining the region in which a touch event occurs. In the embodiment, the identifying module 302 determines the coordinate of the touch signal corresponding to the touch event as belonging to a particular collection or range of coordinates, and determines the particular region which has been touched accordingly. In the embodiment, every region comprises a collection of coordinates within the touch screen 20.

The identifying module 302 is also configured for identifying the type of touch operation and the current display mode, generating signals accordingly, and determining whether the touch operation is a mode switching operation according to the touched region and the current display mode of the electronic device 100.

The mode switching mode 303 is configured for controlling the electronic device 100 to switch the display mode if the touch operation is a mode switching operation when identified as such by the identifying module 302. In the embodiment, if the identifying module 302 identifies that the current display mode is the zooming mode, and the type of the touch results in the size of the displayed page being 100%, the mode switching module 303 controls the electronic device 100 to switch from the zooming mode into the browsing mode. If the identifying module 302 identifies that the current display mode is the browsing mode, and the type of the touch is a doubleclicking operation or a zooming operation on the center region 5 of the displayed page, the mode switching module 303 controls the electronic device 100 to switch from the browsing mode into the zooming mode.

In this embodiment, the doubleclicking operation on the center region 5 includes two touch operations on the center region 5 of the displayed page. The time interval between the two touch operations must be not more than a predetermined time period. The zooming operation on the center region 5 of the displayed page can be two fingers of the user sliding away from each other on the center region 5 of the touch screen 20, that is, a zooming in operation. The zooming operation on the center region 5 of the displayed page can either be two fingers of the user sliding towards each other in a pinching motion on the center region 5 of the touch screen 20, that is, a zooming out operation.

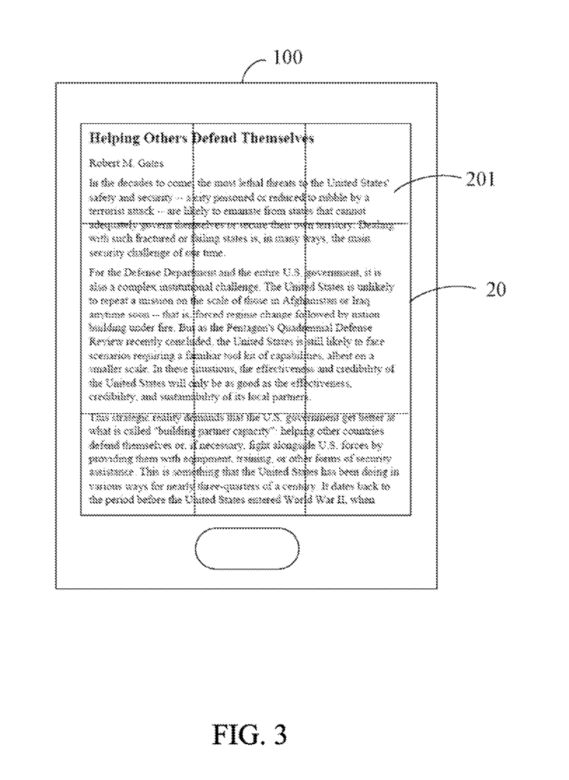

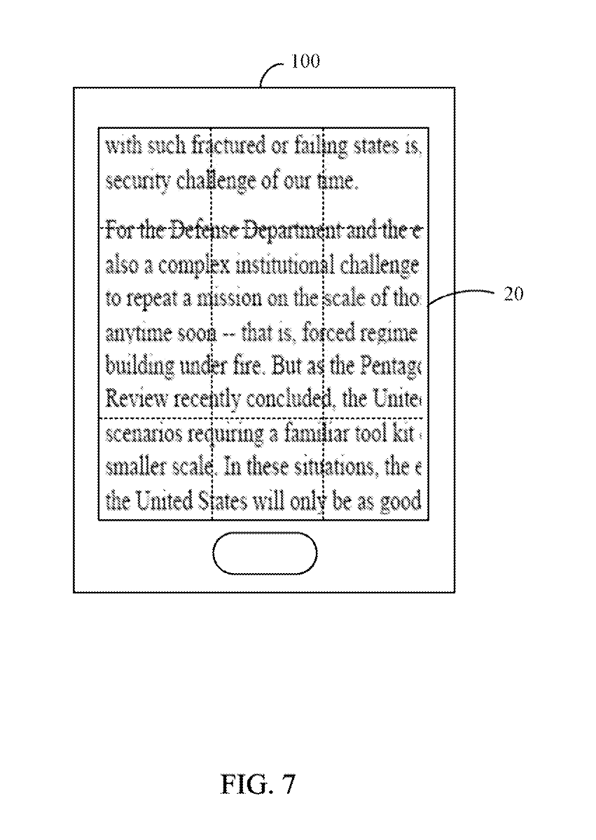

Referring to FIG. 3, in this embodiment, in the browsing mode, the size of the displayed page is 100% in any event and cannot be changed. However when in the zooming mode, the size of the displayed page may be less or more than 100% and can be changed, that is, be zoomed in (see FIG. 7) and be zoomed out, according to the zoom operations.

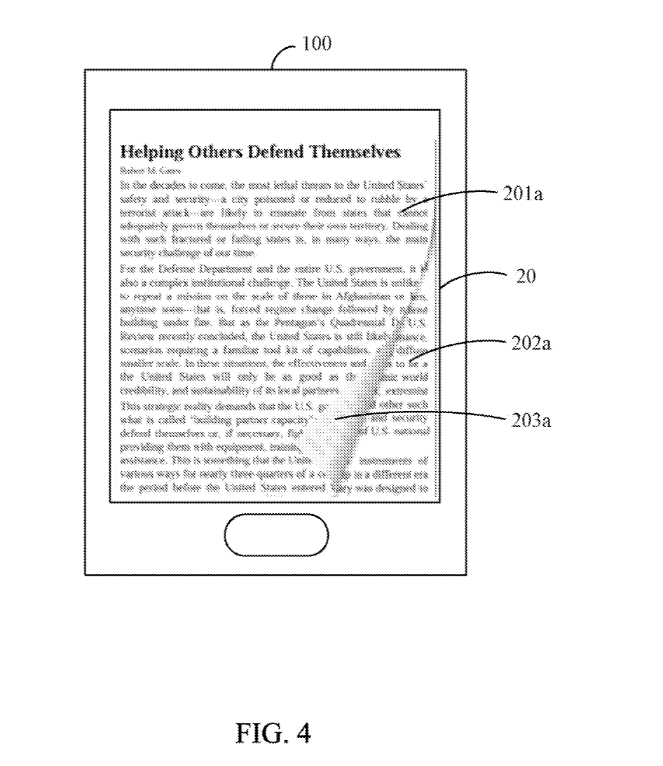

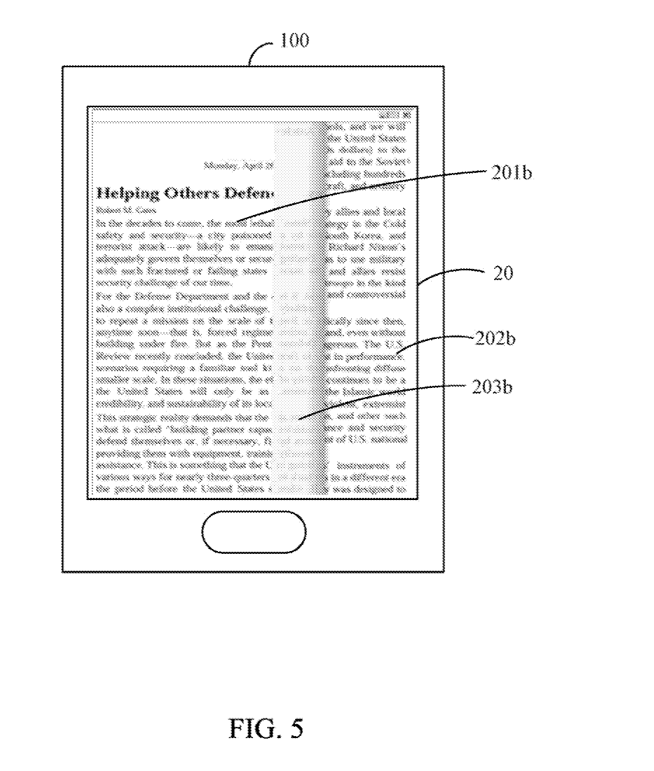

In the embodiment, the default display mode of the electronic device 100 is the browsing mode. In the browsing mode, if the touch operation is applied on one of the peripheral regions, that is, the regions 1-4 or the regions 6-9, the identifying module 302 determines that the touch operation is a page flipping operation, and the page processing module 304 determines the target page according to the particular region which has been touched. The display control module 305 controls the touch screen 20 to display the current or existing page being gradually turned over and the text thereon being obscured or lost from clear sight, and at the same time the text of the target page (the new or replacement page) being gradually revealed in place of the current page, just as if a physical page in a real book was being smoothly turned over. Hereinafter, the expression “effective pages” refers to the display of two pages at once in the manner described. FIG. 4 shows the visible result when a touch operation is applied on the region 9, and FIG. 5 shows the visible result when a touch operation is applied on the region 6. That is, visible results are shown in FIG, 4 or FIG. 5 respectively, as long as a finger or stylus touches on the region 9 or region 6. For example, a finger touches on any point of the region 9 and leaves the region 9 immediately, or a finger touched on any point of the region 9 and keeps touching on the touched point, the visible result is shown in FIG. 4. Each effective page includes three parts: the first part includes part of the current page, the second part is a visual effect part and the third part includes part of the target page.

In the embodiment, if the identifying module determines that the touch operation is applied on one of the regions 1, 2, 4 or 7 of the displayed page, the page processing module 304 determines that the touch operation requires turning back or flipping to a previous page. When the identifying module determines the touch operation is applied on one of the regions 3, 6, 8 or 9 of the displayed page, the page processing module 304 determines that the touch operation requires turning or flipping to a later page. One or more visual effect parts is always visible, that is, curling to the middle from the bottom left or the bottom right corner of the page, as is shown in FIG. 4, when the touch operations are applied on the regions 1, 3, 7 or 9. A different page flipping effect is shown in FIG. 5, when the touch operations are applied on the regions 2, 4, 6 or 8, that is, the whole length of the left margin or the right margin curling to the middle.

If the identifying module 302 determines that the touch traces across more than one region, for example a touch operation which starts from one of the regions 1-4, 6-9 and goes across an approximate predetermined line, such as diagonal L1 or diagonal L2 of the displayed page showing in FIG. 2, the page processing module 304 determines that a current page must be replaced instantaneously with a target page. The display control module 305 controls the touch screen 20 to display the whole target page at once. In an alternative embodiment, the predetermined line(s), crossing zone lines or otherwise, is defined according to actual needs. For example, more than one predetermined line may be defined in one region, the predetermined line may be horizontal or vertical.

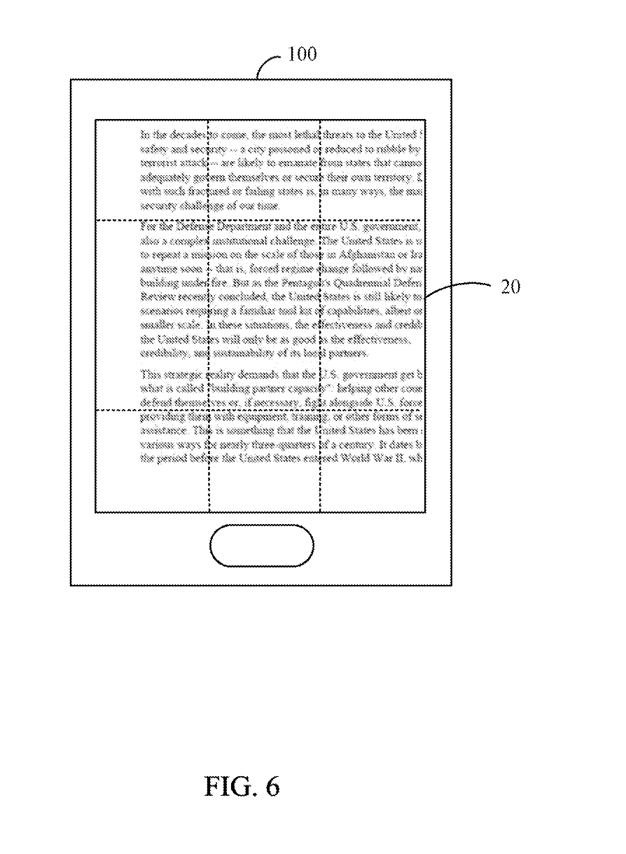

When in the browsing mode, if the user slides his finger on the region 5 of the displayed page, the page processing module 304 moves the page according to the sliding direction and the sliding distance of the touch operation. The display control module 305 displays a determined updated page, such as a pan left page, a pan right page, a pan up page, or a pan down page of the displayed page corresponding to the slide operation. FIG. 6 shows an updated page as a result of a touch operation sliding a certain distance from the region 5 of the displayed page on FIG.3 to the upper right corner. If the identifying module 302 identifies a zooming operation applied on the region 5 of the displayed page, the page processing module 304 generates a zoomed page, and the display control module 305 controls the touch screen 20 to display the zoomed page.

Referring to FIGS. 4 and 5, the effective pages 203a, 203b represents the back of the curved parts of the current page 201. In this embodiment, the sharpness and clarity of the effective pages 203a, 203b are processed, to be made blurred or obscured or grayscale. The page processing module 304 continuously updates the effective pages corresponding to the dynamic coordinate changes of the touch operation, and continuously generates effective pages. In detail, the page processing module 304 determines the coordinates of the effective pages according to the real-time coordinates of the touch operation, the region of the touch operation, and the application of Bezier curves. Then the page processing module 304 generates a simulation of the back of the part of the current page which forms part of the effective pages. Then and thus the effective pages are generated. Generally, the simulated back view within the effective pages is shown dilution of the colors and boldness and clarity of a normal page. The effective pages reveal a curved triangle (as in FIG. 4) or a curved cylinder (as in FIG. 5). If the touch operation of the user is a zooming operation or a panning operation, the page processing module 304 generates an updated page according to the signals. That is, the updated page is the zoomed or panned page of the current page.

The display control module 305 is configured for displaying the combined pages of the effective pages or the updated page on the touch screen 20 according to the signal of the user.

Referring to FIGS. 3-7, the page processing process of the electronic device 100 is shown. As stated above, the default display mode of the electronic device 100 is the browsing mode. As is shown in FIG. 3, the current page 201 is displayed on the touch screen 20. When a finger is moving within the region 9 of the current page 201 (in any direction), the identifying module 302 identifies the touch operation is a page forward flipping operation on the region 9 according to the touch signals transmitted from the touch screen 20. The page processing module 304 retrieves the next page 202 of the current page 201 from the storage unit 10, and generates an effective page 203a as part of the effective pages. In the embodiment, the touch screen 20 detects the real-time coordinates of the touch operation, and the page processing module 304 generates the effective pages accordingly, in real time, and generates combined pages corresponding to the coordinates of the touch operations. The display control module 305 displays the combined pages on the touch screen 20 in real time. Thus, vivid and realistic page flipping effects in a very good simulation of paper books can be enjoyed.

In another embodiment, the touch screen 20 displays a combined page in response to the touch operation on the displayed page when the human finger contacts the touch screen 20. When the traced touch of a touch operation starts from one of the regions 1 and 7 and goes across a predetermined line, such as diagonal L1 and or diagonal L2, the touch screen 20 will display the previous page. In this embodiment, if the user applies a page flipping operation on one of the regions 1, 2, 4, 7, the electronic device 100 flips the page backwards, and if the user applies a page flipping operation on one of the regions 3, 6, 8, 9, the electronic device 100 flips page forward. To avoid repetition, these details are omitted.

Referring to FIG. 5, a schematic figure of the page flipping operation applied on the region 6 is shown. The predetermined lines for region 6 are diagonals L1 and L2. When the traced touch of a touch operation starts from the region 6 and goes across the diagonal L1 or diagonal L2, the touch screen 20 displays the next page. The page flipping operation applied on the region 4 is similar to that on the region 6. The difference is that when the traced touch of a touch operation starts from the region 4 goes across the diagonal L1 or diagonal L2, the touch screen 20 displays the previous page.

When the electronic device 100 is in the zooming mode, the user applies zooming operations on the touch screen 20 to zoom the displayed page. Referring to FIG. 3, the electronic device 100 is in the zooming mode, if the user operates the touch screen 20 via two fingers sliding away from each other, the displayed page is then zoomed in, and if the user pinches two fingers together on the touch screen 20, the displayed page on the touch screen 200 is then zoomed out. When the displayed page is zoomed in, that is, the size of the displayed page is larger than 100%, if the finger of user slides up, down, to the right, or to the left of the touch screen 20, the displayed page moves upwardly, downwardly, rightwardly, and leftwardly accordingly. That is, the displayed page matches the motion of the finger on the touch screen.

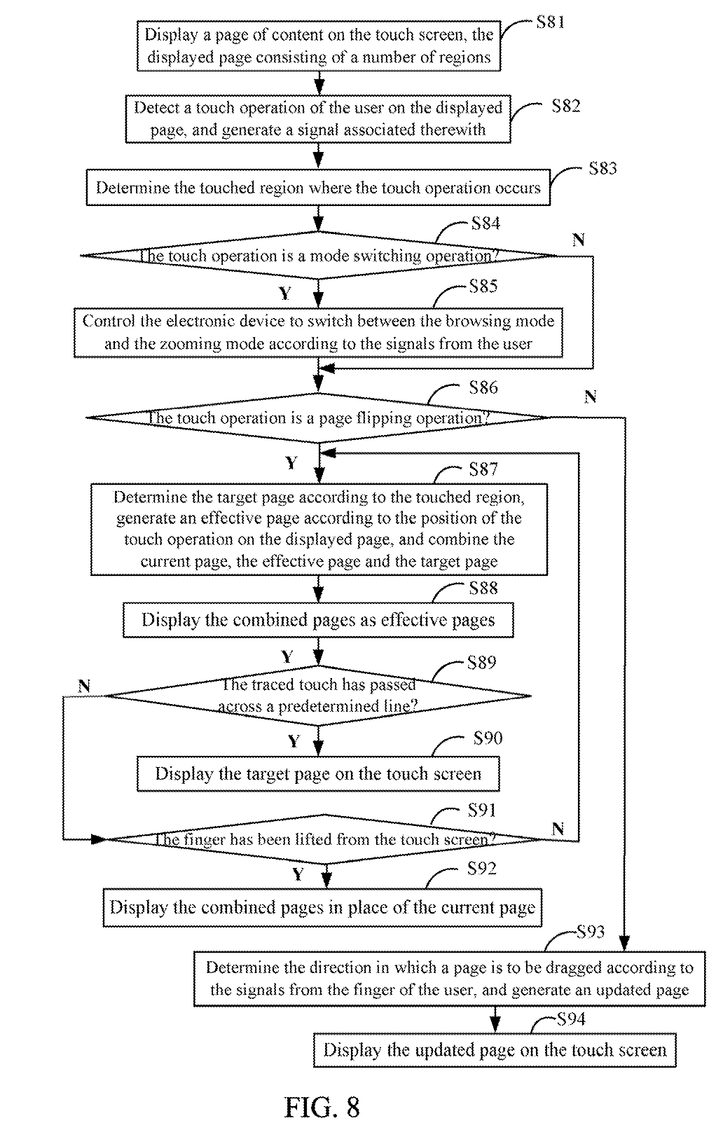

Referring to FIG. 8, a flowchart of a page processing method of the electronic device 100 of FIG. 1 is shown. The method includes the following steps, each of which is connected to the various components contained in the electronic device 100.

In step S81, the zoning module 301 displays a page of content on the touch screen 20, the displayed page consisting of a number of regions. The regions include a center region and a number of peripheral regions surrounding the center region.

In step S82, the touch screen 20 detects a touch operation of the user on the displayed page, and generates a signal associated therewith.

In step S83, the identifying module 302 determines the touched region where the touch operation occurs.

In step S84, the identifying module 302 determines whether the touch operation is a mode switching operation according to the signal, if yes, the process goes to step S85, otherwise, the process goes to step S86. In the embodiment, the identifying module 302 determines that the touch operation is a mode switching operation under the following circumstances: 1) a doubleclicking operation performed in the center region of the displayed page in the browsing mode; 2) a zooming operation performed in the center region of the displayed page in the browsing mode; and 2) adjusting the size of the displayed page to 100% in the zooming mode.

In step S85, the mode switching module 303 controls the electronic device 100 to switch between the browsing mode and the zooming mode according to the signals from the user. In the embodiment, the first mode switching operation stated in step S83 is an operation for switching from the browsing mode to the zooming mode, and the second mode switching operation stated in step S83 is an operation for switching from the zooming mode to the browsing mode.

In step S86, if the identifying module 302 determines that the touch operation is not a mode switching operation, the identifying module 302 then determines whether the touch operation is a page flipping operation, if yes, the process goes to step S87, otherwise, the process goes to step S92. In the embodiment, when the identifying module 302 determines the current display mode of the electronic device 100 is the browsing mode, and a finger touches one of the peripheral regions 1-4, or 6-9, the identifying module 302 determines that the touch operation is a page flipping operation.

In step S87, the page processing module 304 determines the target page according to the touched region, generates an effective page according to the position of the touch operation on the displayed page, and combines the current page, the effective page and the target page.

In step S88, the display control module 305 controls the touch screen 20 to display the combined pages as effective pages.

In step S89, the identifying module 302 determines whether the traced touch of the touch operation has passed across a predetermined line, if yes, the process goes to step S90, otherwise, the process goes to step S91.

In step S90, the display control module 305 controls the touch screen 20 to display the target page determined by the page processing module 304.

In step S91, the identifying module 302 determines whether the finger has been lifted from the touch screen 20, if yes, the process goes to step S92, otherwise, the process goes back to step S87.

In step S92, the display control module 305 controls the touch screen 20 to display the combined pages in place of the current page.

In step S93, the page processing module 304 determines the direction in which a page is to be dragged according to the signals from the finger of the user, and generates an updated page. The updated page is the zoomed or panned page of the current page.

In step S94, the display control module 305 controls the touch screen 20 to display the updated page.

With such a configuration, the user can switch between the browsing mode and the zooming mode by doubleclicking the center region 5 of the displayed page on the touch screen 20 or adjusting the size of the displayed page to 100% in the zooming mode of the electronic device 100. A vivid and realistic page flipping effect is presented to the user of the electronic device 100 when the user touches the peripheral regions of the displayed page, which provides more attractive and comfortable viewing to the user.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. A page processing method for an electronic device with a touch screen, the method comprising:
displaying a page of content on the touch screen, the displayed page consisting of a plurality of regions, the regions comprising a center region and a plurality of peripheral regions surrounding the center region;
detecting a touch operation on the displayed page, and generating a signal associated therewith;
determining the touched region where the touch operation occurs;
determining whether the touch operation is a mode switching operation according to the signal; and
controlling the electronic device to switch between a browsing mode in which the displayed page is unzoomable and a zooming mode in which the displayed page is zoomable according to the signal and the location of the touched region on the displayed page, if the touch operation is a mode switching operation.

2. The method as described in claim 1, wherein the mode switching operation is selected from the group consisting of adjusting the size of the displayed page to 100% in the zooming mode, a doubleclicking operation performed in the center region of the displayed page in the browsing mode, and a zooming operation performed in the center region of the displayed page in the browsing mode.

3. The method as described in claim 1, further comprising:
determining whether the touch operation is a page flipping operation if the touch operation is determined not a mode switching operation;
determining a target page according to the touched region, generating an effective page according to the position of the touch operation on the displayed page, and combining the current page, the effective page and the target page, if the touch operation is a page flipping operation; and
displaying the combined page on the touch screen.

4. The method as described in claim 3, further comprising:
determining whether the traced touch of the touch operation passes across a predetermined line; and
displaying the target page on the touch screen if the traced touch of the touch operation passes across a predetermined line.

5. The method as described in claim 4, further comprising:
displaying the current page in place of the combined page on the touch screen if the traced touch of the touch operation does not pass across the predetermined line.

6. The method as described in claim 3, wherein the page flipping operation is a finger touching one of the periphery regions in the browsing mode.

7. The method as described in claim 3, wherein coordinates of the effective pages are determined according to the real-time coordinates of the touch operation, the touched region, and application of Bezier curves, and the effective pages comprise a simulation of the back of a part of the current page.

8. The method as described in claim 3, wherein the predetermined line comprises one or more diagonals of the displayed page.

9. An electronic device, comprising:
a touch screen configured for displaying a page of content and detecting a touch operation on the displayed page and generating a signal associated therewith; and
a processor comprising:
a zoning module, configured to divide a displayed page on the touch screen into a plurality of regions comprising a center region and a plurality of peripheral regions surrounding the center region;
an identifying module configured to determine a region in which a touch event occurs according to the signal, and to determine whether the touch operation is a switching operation according to the touched region; and
a mode switching module configure to control the electronic device to switch the display mode if the touch operation is a mode switching operation.

10. The electronic device as described in claim 9, wherein the mode switching module is configured to control the electronic device to enter a browsing mode if the size of the displayed page is adjusted to 100% in the zooming mode.

11. The electronic device as described in claim 9, wherein the mode switching module is configured to control the electronic device to enter a zooming mode if a doubleclicking operation or a zooming operation on the center region of the displayed page in the browsing mode is detected.

12. The electronic device as described in claim 9, wherein the identifying module is further configured to determine whether the touch operation is a page flipping operation if the touch operation is determined not a mode switching operation; the processor further comprises:
a page processing module configured to determine a target page according to the touched region, to generate an effective page according to the position of the touch operation, and to generate a combined page combining the current page, the effective page and the target page, if the touch operation is a page flipping operation; and
a displaying module configured to display the combined page on the touch screen, to display the target page on the touch screen if the traced touch of the touch operation passes across a predetermined line, and to display the current page in place of the combined page on the touch screen if the traced touch of the touch operation does not pass across the predetermined line.

13. The electronic device as described in claim 12, wherein the predetermined line comprises one or more diagonals of the displayed page.

14. The electronic device as described in claim 9, wherein the page flipping operation is a finger touching one of the periphery regions in the browsing mode.

15. The electronic device as described in claim 9, wherein the coordinates of the effective page are determined according to the real-time coordinates of the touch operation, the region of the touch operation, and the application of Bezier curves, and the effective pages comprise a simulation of the back of the current page.

16. The electronic device as described in claim 9, being an electronic reader.

17. A page processing method for an electronic device with a touch screen, the method comprising:
detecting a touch event applied on the touch screen, the touch screen displaying a page comprising a center region and a plurality of peripheral regions surrounding the center region;
determining a touched region on the page and the type of the touch event, wherein the type of the touch event is selected from the group consisting of clicking on one of the peripheral regions, doubleclicking on the center region, clicking and dragging on a center region or a peripheral region, sliding on a center region or a peripheral region, and sliding across a predetermined line on one of the peripheral regions; and
executing an instruction corresponding to the type of the couch event in the touched region wherein the instruction is selected from the group consisting of displaying an effective page with curling to the middle from one of the page corners; switching between a browsing mode and a zooming mode, displaying an updated page corresponding to the touch event, and displaying a combined page simulating the turning of a page.

18. The method as described in claim 17, further comprising:
determining a target page corresponding to the touch event, wherein the target page being selected from the group consisting of the effective page, the updated page, and the combined page; and
displaying the target page.
